(19) United States
(12) Patent Application Publication
(10) Pub. No.: US 2021/0073577 A1
(43) Pub. Date: Mar. 11, 2021

(54) IMAGE PROCESSING METHOD AND DEVICE, ELECTRONIC DEVICE AND STORAGE MEDIUM

(71) Applicant: SHENZHEN SENSETIME TECHNOLOGY CO., LTD., Shenzhen (CN)

(72) Inventors: Chuibi HUANG, Shenzhen (CN); Kang WANG, Shenzhen (CN); Yuheng CHEN, Shenzhen (CN); Tao MO, Shenzhen (CN); Xiao JIN, Shenzhen (CN)

(21) Appl. No.: 16/953,875

(22) Filed: Nov. 20, 2020

Related U.S. Application Data
(63) Continuation of application No. PCT/CN2019/101438, filed on Aug. 19, 2019.

(30) Foreign Application Priority Data
May 15, 2019 (CN) 201910404653.9

(51) Int. Cl. G06K 9/62; G06K 9/46; G06K 9/00

(52) U.S. Cl. CPC G06K 9/6218; G06K 9/46; G06K 9/00288; G06K 9/6269; G06K 9/00268; G06K 9/6215

(57) ABSTRACT

An image processing method includes: performing feature-extracting processing on a plurality of images in an image data set to obtain image features respectively corresponding to the plurality of images; performing clustering processing on the plurality of images based on the obtained image features to obtain at least one cluster, herein images in a same cluster include a same object. A distributed and parallel manner is adopted to perform the feature-extracting processing and at least one processing procedure of the clustering processing.

### CROSS-REFERENCE TO RELATED APPLICATIONS

The present application is a continuation of International Application No. PCT/CN2019/101438, filed on Aug. 19, 2019, which claims priority to Chinese Patent Application No. 201910404653.9, filed on May 15, 2019. The disclosures of International Application No. PCT/CN2019/101438 and Chinese Patent Application No. 201910404653.9 are hereby incorporated by reference in their entireties.

### BACKGROUND

With the construction of smart cities, city-level monitoring systems are capturing a myriad of human face pictures every day. The human face data are characterized by a large amount, distribution over a broad area, many duplicates, lack of identities and so on. The current video analysis system is not able to perform a quick and effective clustering analysis on a copious amount of image data

### SUMMARY

The disclosure relates to computer vision technology, and particularly to an image processing method and device, an electronic device and a storage medium.

An image processing technical solution is provided in the embodiments of the disclosure.

An aspect according to the embodiments of the disclosure provides an image processing method, the method including: performing feature-extracting processing on a plurality of images in an image data set to obtain image features respectively corresponding to the plurality of images; performing clustering processing on the plurality of images based on the obtained image features to obtain at least one cluster, herein images in a same cluster include a same object, and a distributed and parallel manner is adopted to perform the feature-extracting processing and at least one processing procedure of the clustering processing.

A second aspect according to the embodiments of the disclosure provides an image processing device, the device including: a memory storing processor-executable instructions; and a processor arranged to execute the stored processor-executable instructions to perform operations of: performing feature-extracting processing on a plurality of images in an image data set to obtain image features respectively corresponding to the plurality of images; and performing clustering processing on the plurality of images based on the obtained image features to obtain at least one cluster, wherein images in a same cluster comprise a same object, herein a distributed and parallel manner is adopted to perform the feature-extracting processing and at least one processing procedure of the clustering processing.

A third aspect according to the embodiments of the disclosure provides a non-transitory computer-readable storage medium having stored thereon computer-readable instructions that, when executed by a processor, cause the processor to perform an image processing method, the method including: performing feature-extracting processing on a plurality of images in an image data set to obtain image features respectively corresponding to the plurality of images; and performing clustering processing on the plurality of images based on obtained image features to obtain at least one cluster, wherein images in a same cluster comprise a same object, where a distributed and parallel manner is adopted to perform the feature-extracting processing and at least one processing procedure of the clustering processing.

It is to be understood that the above general descriptions and detailed descriptions below are only exemplary and explanatory and not intended to limit the present disclosure.

Other features and aspects of the disclosure will be made clear by detailed descriptions of exemplary embodiments with reference to accompanying drawings below

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of an image processing method according to an embodiment of the disclosure;

FIG. 2 is a flowchart of operation S10 in an image processing method according to an embodiment of the disclosure;

FIG. 3 is a flowchart of operation S20 in an image processing method according to an embodiment of the disclosure;

FIG. 4 is a flowchart of operation S21 in an image processing method according to an embodiment of the disclosure;

FIG. 5 is a flowchart of operation S22 in an image processing method according to an embodiment of the disclosure;

FIG. 6 is a flowchart of operation S223 in an image processing method according to an embodiment of the disclosure;

FIG. 7 is another flowchart of operation S223 in an image processing method according to an embodiment of the disclosure;

FIG. 8 is a flowchart of performing clustering incremental processing in an image processing method according to an embodiment of the disclosure;

FIG. 9 is a flowchart of operation S43 in an image processing method according to an embodiment of the disclosure;

FIG. 10 is a flowchart of determination of an object identity matching a cluster in an image processing method according to an embodiment of the disclosure;

FIG. 11 is a block diagram of an image processing device according to an embodiment of the disclosure;

FIG. 12 is a block diagram of an electronic device according to an embodiment of the disclosure;

FIG. 13 is another block diagram of an electronic device according to an embodiment of the disclosure.

### DETAILED DESCRIPTION

Various exemplary embodiments, features and aspects of the present disclosure are described in detail below with reference to the accompanying drawings. Elements with same functions or similar elements are represented by a same reference sign in an accompanying drawing. Although each aspect of the embodiments is illustrated in the accompanying drawing, the drawings do not have to be plotted to scale unless specifically indicated.

Herein the specific word “exemplary” means “used as an example or an embodiment, or descriptive”. Herein it is not necessary to explain that any embodiment described as “exemplary” is superior to or better than other embodiments.

The term “and/or” in the disclosure only represents an association relationship for describing associated objects, and may represent three relationships. For example, A and/or B may represent three conditions: i.e., only A, both A and B, and only B. In addition, herein the term “at least one” represents “any one of many” or “any combination of at least two of many” For example, “including at least one of A, B or C” may represent that “selecting one or more elements from among a set composed of A, B and C”.

In addition, a great many details are given in the following detailed description to make the disclosure better described. Those skilled in the art should understand the disclosure is also able to be implemented in the absence of some details. In some examples, methods, means, elements and electric circuits familiar to those skilled in the art are not described in detail to make the main idea of the disclosure shown clearly.

An image processing method is provided in the embodiments of the disclosure. The method may be used for images to cluster quickly. In addition, the image processing method may be applied to any image processing device. For example, the image processing method can be performed by a terminal device, a server or other processing devices. The terminal device may be User Equipment (UE), a mobile device, a user terminal, a terminal, a cellular phone, a cordless phone, a Personal Digital Assistant (PDA), a handheld device, a computing device, a vehicle-mounted device, a wearable device or the like. In some possible implementations, the image processing method may be implemented in a manner of a processor's performing computer-readable instructions stored in a memory. The above is only an exemplary description. The image processing method may also be performed through other equipment or devices in other embodiments.

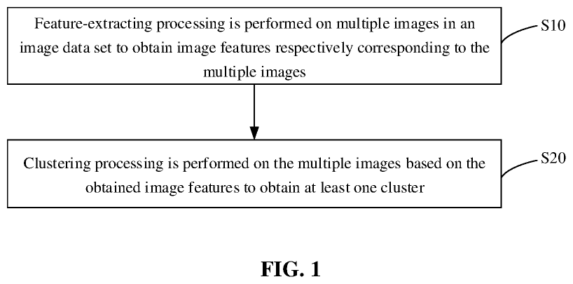

FIG. 1 is a flowchart of an image processing method according to an embodiment of the disclosure. As illustrated in FIG. 1, the image processing method may include operations S10 to S20:

In operation S10, feature-extracting processing is performed on multiple images in an image data set to obtain image features respectively corresponding to the multiple images;

In operation S20, clustering processing is performed on the multiple images based on the obtained image features to obtain at least one cluster. Images in a same cluster include a same object.

The feature-extracting processing and at least one of clustering processing procedures in the image processing method provided in the embodiment of the disclosure may be performed in a distributed and parallel manner. The distributed and parallel manner may speed up the extraction of the features and the clustering processing, which further makes the processing of the images faster. A detailed process of the embodiment of the disclosure is described below in detail in combination with the accompanying drawing.

Firstly the image data set may be obtained. In some possible implementations, the image data set may include multiple images that may be images acquired by at least one image-acquiring device. For example, the images may be captured by cameras installed on roadsides, in public areas, in office buildings, security defense areas or may be captured by devices including cellphones and cameras. The embodiment of the disclosure is not limited thereto.

In some possible implementations, the images in the image data set in the embodiment of the disclosure may include objects of a same type. For example, the multiple images in the image data set may all include human objects and space-time trajectory information of the corresponding human objects may be obtained by the image processing method in the embodiment of the disclosure. In other embodiments, the multiple images in the image data set may all include objects of other types such as animals, moving objects (e.g., aircraft) so that space-time trajectories of corresponding objects may be determined.

In some possible implementations, the operation of obtaining the image data set may be performed before operation S10. The manner of obtaining the image data set may include connecting to the image-acquiring device directly to receive the images acquired by the image-acquiring device or connecting to a server or another electronic device to receive the images transmitted by the server or the electronic device. In addition, the images in the image data set in the embodiment of the disclosure may also be images that have been preprocessed. For example, the preprocessing may be clipping an image including a human face (a human face image) out from the acquired image or deleting blurrier images with low Signal-to-Noise Ratios (SNRs) or images that do not include human objects from the acquired images. The above is only an exemplary description. A detailed manner of obtaining the image data set is not limited in the embodiment of the disclosure.

In some possible implementations, the image data set may also include a third index associated with each image. The third index is used for determining space-time data corresponding to the images. The space-time data include at least one of time data or space position data. For example, the third index may include at least one of: a time when the images are acquired, a position where the images are acquired, an identifier of the image-acquiring device that acquire the images, a position where the image-acquiring device is installed and numbers configured for the images. Thus, it may be possible to determine Space-time data information, such as a time when the objects in the images appear and a position where the objects appear, through the third indexes associated with the images.

In some possible implementations, when acquiring an image and transmitting the acquired image, the image-acquiring device may transmit the third index of the image. For example, the image-acquiring device may transmit information such as a time when the image is acquired, a position where the image is acquired and an identifier of the image-acquiring device (such as a camera) that acquires the image. After the image and the third index are received, the image may be stored in association with its corresponding third index in a place such as a database. The database may be a local database or a cloud database and is convenient for data to be read and invoked.

After the image data set is obtained, the feature-extracting processing may be performed on the images in the image data set according to operation S10 in the embodiment of the disclosure. In some possible implementations, the image features of the images may be extracted through a feature-extracting algorithm or may also be extracted by a trained neural network capable of extracting the features. The images in the image data set in the embodiment of the disclosure are human face images. The image features, which are obtained after being processed by the feature-extracting algorithm or the neural network, may be human face features of human face objects. The feature-extracting algorithm may include at least one of algorithms including Principal Components Analysis (PCA), Linear Discriminant Analysis (LDA), Independent Component Correlation Algorithm (ICA), or other algorithms that are able to recognize a human face area and obtain the feature of the human face area. The neural network may be a convolutional neural network such as a Visual Geometry Group (VGG) network. The convolutional neural network performs convolutional processing on the images to obtain the features of the human face areas in the images, namely the human face features. The feature-extracting algorithm and the neural network that extracts the features are not limited specifically in the embodiment of the disclosure. Anything that may extract the human face features (the image features) may serve as the embodiment of the disclosure.

In addition, in some possible implementations, the image feature of each image may be extracted in the distributed and parallel manner in the embodiment of the disclosure in order to make the extraction of the image features faster.

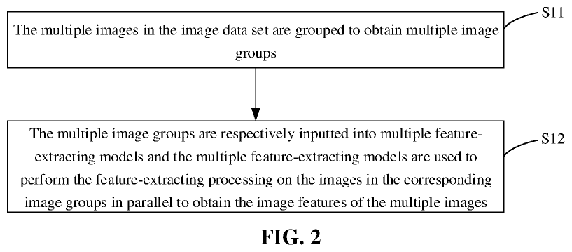

FIG. 2 is a flowchart of operation S10 in an image processing method according to an embodiment of the disclosure; The operation that feature-extracting processing is performed on multiple images in the image data set to obtain the image features corresponding to the images (operation S10) may include operations S11 to S12.

In operation S11, the multiple images in the image data set are grouped to obtain multiple image groups.

In some possible implementations, the multiple images in the image data set may be grouped to obtain the multiple image groups, each of which may include at least one image. The images may be grouped evenly or randomly. The number of the obtained image groups may be a number that is configured in advance and may be less than or equal to the number of following feature-extracting models.

In operation S12, the multiple image groups are respectively inputted into multiple feature-extracting models and the multiple feature-extracting models are used to perform the feature-extracting processing on the images in the corresponding image groups in parallel to obtain the image features of the multiple images. The image groups inputted into respective feature-extracting models are different from each other.

In some possible implementations, based on the obtained multiple image groups, the feature-extracting processing procedure may be implemented in the distributed and parallel manner. Each of the obtained multiple image groups may be allocated to one of the feature-extracting models. The feature-extracting processing is performed on the images in the allocated image groups through the feature-extracting models to obtain the image features of the corresponding images.

In some possible implementations, the feature-extracting models may adopt the above feature-extracting algorithm to perform the feature-extracting processing or may build the above feature-extracting neural network to obtain the image features. The embodiment of the disclosure is not limited specifically thereto.

In some possible implementations, the multiple feature-extracting model are adopted to extract the features from each image group in a distributed and parallel manner. For example, each feature-extracting model may extract the image features from one or more image groups simultaneously, which speeds up the feature extraction.

In some possible implementations, the method further includes a following operation: after the image features of the images are obtained, third indexes of the image features are obtained; the third indexes are stored in association with the image features corresponding to respective third indexes; a mapping relationship between the third indexes and the image features are established and may be stored in a database. For example: a monitored real-time picture stream may be inputted into a front-end distributed feature-extracting module (the feature-extracting model); after the distributed feature-extracting module extracts the image features, the image features are stored in a form of persistent features in a feature database based on space-time information, that is to say, the third indexes and the image features are stored in the form of the persistent features in the feature database. The persistent features are stored in a form of an index structure in the database. A key of the third indexes of the persistent features in the database may include Region id, Camera idx, Captured time and Sequence. Region id is an identifier of a camera area, Camera idx is a camera id in the area, Captured time is an acquiring time of the pictures, Sequence id is an auto-incrementing sequence identifier that may be used for removing duplicates such as a number sequence. The third index may serve as a unique identifier of each image feature and include the space-time information of the image feature. The image feature (the persistent feature) of each image may be obtained conveniently and space-time data information (the time and the position) may be known, after the third indexes are stored in association with the image features corresponding to respective third indexes.

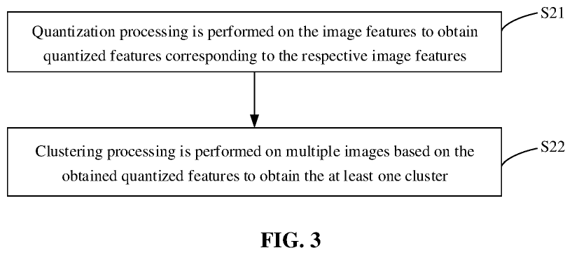

Clustering processing may be performed on the images based on the image features of the images to form at least one cluster. Images included in each of the obtained clusters are the images of a same object. FIG. 3 is a flowchart of operation S20 in an image processing method according to an embodiment of the disclosure. The operation that clustering processing is performed on the multiple images based on the obtained image features to obtain the at least one cluster (S30) may include operations S21 to S22.

In operation S21, quantization processing is performed on the image features to obtain quantized features corresponding to the respective image features.

After the image features of the images are obtained, the quantized feature of each image feature may be further obtained. For example, the quantization processing may be performed on the image features directly according a quantization encoding algorithm to obtain the corresponding quantized features. In the embodiment of the disclosure, Product Quantization (PQ) encoding may be adopted to obtain the quantized features of the images in an image data set. For example, the quantization processing is performed through a PQ quantizer. A procedure of performing the quantization processing through the PQ quantizer may include resolution of a vector space of the image feature into Cartesian products of multiple low-dimensional vector spaces and the quantization of each low-dimensional vector space obtained after the resolution. In this case, each image feature may be represented by a quantization combination of multiple low-dimensional spaces, thus the quantized features are obtained. A detailed process of the PQ encoding is not described in detail in the embodiment of the disclosure. Data compression of the image features may be implemented through the quantization processing. For example, in the embodiment of the disclosure the image features of the images may have a dimension of N with data in each dimension being floating point numbers of a type “float32” and the quantized features obtained after the quantization processing may have a dimension of N with data in each dimension being half floating point numbers. In other words, the quantization processing may reduce the data amount of the features.

According to the descriptions in the above embodiment, the quantization processing may be performed on the image features of all the images through at least one quantizer to obtain the quantized features corresponding to all the images. The quantization processing may be performed on the image features through the multiple quantizers in the distributed and parallel manner, which speeds up the processing.

In operation S22, the clustering processing is performed on the multiple images based on the obtained quantized features to obtain the at least one cluster.

After the quantized features are obtained, the clustering processing may be performed on the images according to the quantized features. Since the quantized features have less amount of feature data than original image features, the processing may be sped up in a calculation process and the clustering is also made faster. Since feature information remains in the quantized features, an accuracy of the clustering is guaranteed.

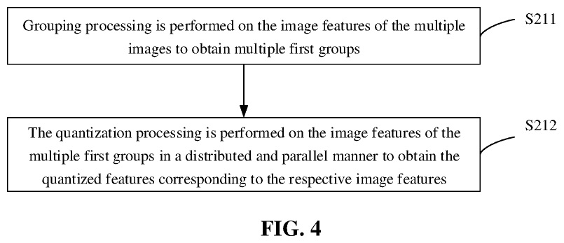

A Detailed description of the quantization processing and the clustering processing is given as follows. According to the above embodiment, in the embodiment of the disclosure, the quantization processing may be performed in the distributed and parallel manner to speed up the acquisition of the quantized features. FIG. 4 is a flowchart of operation S21 in an image processing method according to an embodiment of the disclosure. The operation that the quantization processing is performed on the image features of the images to obtain the quantized features corresponding to the respective image features may include operations S211 to S212.

In operation S211, grouping processing is performed on the image features of the multiple images to obtain multiple first groups. The first group includes the image features of at least one image.

In the embodiment of the disclosure, the image features may be grouped and the quantization processing is performed on the image features in each group in a distributed and parallel manner to obtain the corresponding quantized features. When the quantization processing is performed on the image features of a image data set through multiple quantizers, the quantization processing may be performed on the image features of different images through the multiple quantizers in the distributed and parallel manner. In this way, the quantization processing may take less time and calculation is made faster.

When the quantization processing procedure is performed on each image feature in parallel, the image features may be grouped into multiple groups (the multiple first groups). The manner that the image features are grouped into the first groups may be same as the above manner that the images are grouped (into image groups). In other words, the image features are grouped into a corresponding number of groups in the manner of grouping the images, which means that the image features of the directly obtained image groups may determine the groups of the image features. Alternatively, the image features may also be regrouped into multiple first groups. The embodiment of the disclosure is not limited thereto. Each first group at least includes the image feature of one image. The number of the first groups is not limited in the embodiment of the disclosure and may be determined according to the number, processing capabilities of the quantizers and the number of the images in a comprehensive way. Those skilled in the art or a neural network may determine the number of the first groups according to actual demands.

In addition, in the embodiment of the disclosure, the manner of performing the grouping processing on the image features of the multiple images may include: even grouping or random grouping of the image features of the multiple images. In other words, in the embodiment of the disclosure, the image features of all images in the image data set may be grouped evenly according to the number of the groups or grouped randomly to obtain the multiple first groups. Anything that is able to group the image features of the multiple images into the multiple first groups may serve as the embodiment of the disclosure.

In some possible implementations, after the image features are grouped to obtain the multiple first groups, an identifier (such as a first index) may be allocated to each first group, and the first indexes are stored in association with the first groups. For example, all the image features in the image data set may constitute an image feature library T (a feature database) and then the image features in the image feature library T are grouped (fragmented) to obtain n first groups: {S₁, S₂, . . . Sₙ}; Sᵢ represents an i-th first group, where i is an integer greater than or equal to 1 and less than or equal to n. n represents the number of the first groups and is an integer greater than or equal to 1. Each first group may include the image features of at least one image. In order to make it easy for each first group to be distinguished from each other and make the quantization processing convenient, corresponding first indexes {I₁₁, I₁₂, . . . I₁ₙ} may be allocated to each first group; the first index of the first group Sᵢ may be I₁ᵢ.

In operation S212, the quantization processing is performed on the image features of the multiple first groups in the distributed and parallel manner to obtain the quantized features corresponding to the respective image features.

In some possible implementations, after the image features are grouped to obtain the multiple (at least two) first groups, the quantization processing may be performed in parallel on the image features in each first group respectively. For example, the quantization processing may be performed by multiple quantizers, each of which may perform the quantization processing on the image features of one or more first groups; in this case, the processing is sped up.

In some possible implementations, a corresponding quantization processing task may also be assigned to each quantizer according to the first index of each first group. The operation that the quantization processing is performed on the image features of the multiple first groups in the distributed and parallel manner to obtain the quantized features corresponding to the respective image features includes following operations: each of the first indexes of the multiple first groups is allocated to a respective one of the multiple quantizers, herein the first indexes allocated to respective quantizers are different from each other; and the quantization processing task is performed on the image features in the first groups corresponding to respective allocated first indexes in a parallel manner using the multiple quantizers, that is to say, the quantization processing is performed on the image features in the corresponding first groups.

In addition, in order to further speed up the quantization processing, the number of the quantizers may be made greater than or equal to the number of the first groups and at most one first index may be allocated to each quantizer, which means that each quantizer may perform the quantization processing on the image features in the first group corresponding to only one first index. However, the above does not serve as a specific limitation on the embodiment of the disclosure. The number of the groups, the number of the quantizers, and the number of the first indexes allocated to each quantizer may be set on demand.

According to the descriptions of the above embodiment, the quantization processing may reduce the data amount of the image features. The manner of the quantization processing in the embodiment of the disclosure may be PQ encoding. For example, PQ quantizers perform the quantization processing. Data compression of the image features may be implemented through the quantization processing. For example, in the embodiment of the disclosure the image features of the images may have a dimension of N with data in each dimension being floating point numbers of a type “float32” and the quantized features obtained after the quantization processing may have a dimension of N with data in each dimension being half floating point numbers. In other words, the quantization processing may reduce the data amount of the features.

The above embodiment may enable the quantization processing to be performed in the distributed and parallel manner, which makes the quantization processing faster.

After the quantized features of the images in the image data set are obtained, the quantized features may be stored in association with third indexes, so that the first indexes, the third indexes, the images, the image features and the quantized features are stored in association with one another, and data are read and invoked easily.

In addition, after the quantized features of the images are obtained, clustering processing may be performed on the image data set using the quantized feature of each image. The images in the image data set may include a same object or different objects. In the embodiment of the disclosure, the clustering processing may be performed on the images to obtain multiple clusters. The images in each of the obtained clusters include a same object.

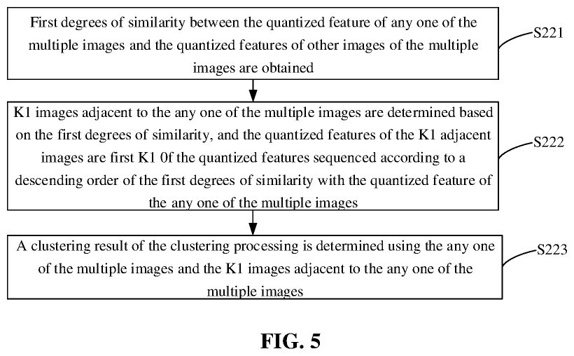

FIG. 5 is a flowchart of operation S22 in an image processing method according to an embodiment of the disclosure. The operation that the clustering processing is performed on the multiple images based on the obtained quantized features to obtain the at least one cluster (operation 22) may include operations S221 to S223.

In operation S223, first degrees of similarity between the quantized feature of any one of the multiple images and the quantized features of other images of the multiple images are obtained.

In some possible implementations, after the quantized features corresponding to the respective image features of the images are obtained, the clustering processing may be performed on the images based on the quantized features, that is to say, the clusters of the same object (the clusters of the objects with a same identity) are obtained In the embodiment of the disclosure, the first degree of similarity between any two quantized features, which may be a cosine degree of similarity, may be obtained firstly. In other embodiments, the first degrees of similarity between the quantized features may be determined in other manners. The embodiment of the disclosure is not limited thereto.

In some possible implementations, an arithmetic unit may be adopted to calculate the first degree of similarity between any two quantized features or multiple arithmetic units may also be adopted to calculate the first degrees of similarity between each quantized feature in a distributed and parallel manner. The distributed and parallel manner adopted by the multiple arithmetic units may speed up the calculation.

Likewise, in the embodiment of the disclosure, based on grouping of the quantized features, the first degrees of similarity between the quantized features in each group and other quantized features may also be calculated in the distributed manner. The method further includes a following operation: before the first degrees of similarity between the quantized feature of any one of multiple images and the quantized features of the other images of the multiple images are obtained, the quantized features of the multiple images are grouped to obtain multiple second groups. The second group includes the quantized feature of at least one image. The second groups may be determined based on the first groups, that is to say, the corresponding quantized features are determined according to the image features of the first groups and the second groups are formed directly according to the quantized features corresponding to the respective image features in the first groups. Alternatively, the quantized features of the images may be regrouped to obtain the multiple second groups. Likewise, the grouping may be even grouping or random grouping. The embodiment of the disclosure is not limited thereto.

In this implementation, the operation that the first degrees of similarity between the quantized feature of any one of the multiple images and the quantized features of the other images of the multiple images are obtained includes a following operation: the first degrees of similarity between the quantized features of the images in the second groups and the quantized features of the other images are obtained in the distributed and parallel manner.

In an optional embodiment of the disclosure, the method further includes: before the first degrees of similarity between the quantized features of the images in the second groups and the quantized features of the other images are obtained in the distributed and parallel manner, a second index is configured for each of the multiple second groups to obtain multiple second indexes. The operation that the first degrees of similarity between the quantized features of the images in the second groups and the quantized features of the other images are obtained in the distributed and parallel manner includes: a similarity degree calculation task corresponding to the second indexes is established based on the second indexes, the similarity degree calculation task obtaining the first degrees of similarity between a quantized feature of a target image in each of the second groups corresponding to a respective one of the second indexes and the quantized features of all images other than the target image in the second group; and a similarity degree acquisition task corresponding to each of the multiple second indexes is performed in the distributed and parallel manner.

After the multiple second groups are obtained the second index may also be configured for each second group so that the multiple second indexes are obtained. The second groups may be distinguished from each other through the second indexes. The second indexes may be stored in association with the second groups. For example, the quantized features of all the images in the image data set may constitute a quantized feature library L, or the quantized features may also be stored associatively in the above image feature library T. The quantized features, the images, the image features, the first indexes, the second indexes, the third indexes may be stored in association with one another. The grouping (fragmentation) of the quantized features in the quantized feature library L may obtain m second groups {L₁, L₂, . . . Lₘ}, where Lⱼ represents a j-th second group, j is an integer greater than or equal to 1 and less than or equal to m, m represents the number of the second groups and is an integer greater than or equal to 1. In order to make the second groups easily distinguished from each other and make the clustering processing convenient, the corresponding first indexes {I₂₁, I₂₂, . . . I₂ₘ} may be allocated to the second groups. The second index of the second group Lⱼ may be I₂ⱼ.

After the multiple second groups are obtained, the multiple arithmetic units may be adopted to respectively calculate the first degrees of similarity between the quantized features in the multiple second groups and other quantized features. Since it is likely that there is a large amount of data in the image data set, multiple arithmetic units may be adopted to calculate the first degrees of similarity between any quantized feature in each second group and all other quantized features in parallel.

Some possible implementations may involve multiple arithmetic units. The arithmetic unit may be any electronic device with a calculation processing function such as a Central Processing Unit (CPU), a processor, a Single-Chip Microcomputer (SCM). The embodiment of the disclosure is not limited thereto. Each arithmetic unit may calculate the first degrees of similarity between each quantized feature in one or more second groups and the quantized features of all the other images, which speeds up the processing.

In some possible implementations, the corresponding similarity degree calculation task may also be assigned to each arithmetic unit according to the second index of each second group. The second index of each second group may be respectively allocated to multiple arithmetic units and the second index allocated to one arithmetic unit is different from the second index allocated to another arithmetic unit. The arithmetic units respectively perform the similarity calculation task corresponding to the second index allocated to the unit in parallel. The similarity degree calculation task obtains the first degrees of similarity between a quantized feature of an image in each of the second groups corresponding to a respective one of the second indexes and the quantized features of all images other than the image. In this case, by the parallel manner adopted by the multiple arithmetic units, the first degree of similarity between the quantized features of any two images are obtained quickly.

In addition, in order to make the calculation of the degrees of similarity faster, the arithmetic units may be made to outnumber the second groups. At the same time, at most one second index may be allocated to each arithmetic unit so that each arithmetic unit only calculates the first degrees of similarity between the quantized features in the second index corresponding to one second index and other quantized features. However, the above does not serve as a specific limitation on the embodiment of the disclosure, the number of the groups, the number of the arithmetic units, the number of the second indexes allocated to each arithmetic unit may be set on demand.

In the embodiment of the disclosure, since the number of quantized features are slashed compared with the image features, the calculation costs less. The parallel processing performed by the multiple arithmetic units may further speed up the calculation.

In operation S222, K1 images adjacent to the any one of the multiple images are determined based on the first degrees of similarity. The quantized features of the K1 adjacent images are the first K1 of the quantized features sequenced according a descending order of the first degrees of similarity with the quantized feature of the any one of the multiple images. K1 is an integer greater than or equal to 1.

After the first degree of similarity between any two quantized features is obtained, the K1 images adjacent to the any one of the multiple images may be obtained, that is to say, the K1 adjacent images are the images corresponding to the first K1 of the quantized features sequenced according to a descending order of the first degrees of similarity with the quantized feature of the any one of the multiple images. The any one of the multiple images is adjacent to the images corresponding to the K1 quantized features with the greatest first degrees of similarity, which shows that the adjacent images may include a same object. A first similarity degree sequence for any quantized feature may be obtained. The first similarity degree sequence is a sequence in which the quantized features are put in a descending or ascending order according to the quantized features' first degrees of similarity with the any one of the multiple images. After the first similarity degree sequence is obtained, it is convenient to determine the first K1 of the quantized features sequenced according to a descending order of the first degrees of similarity with the quantized feature of the any one of the multiple images; thus the K1 images adjacent to the any one of the multiple images are determined. K1 may be determined according to the number of the images in the image data set. K1 may be 20, 30 or set to another value in other embodiments. The embodiment of the disclosure is not limited thereto.

In operation S223, a clustering result of the clustering processing is determined using the any one of the multiple images and the K1 images adjacent to the any one of the multiple images.

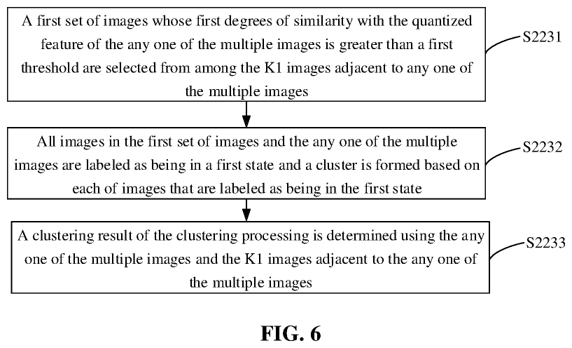

In some possible implementations, after K1 images adjacent to each image are obtained, the subsequent clustering processing may be performed. FIG. 6 is a flowchart of operation S223 in an image processing method according to an embodiment of the disclosure. The operation that the clustering result of the clustering processing is determined using the any one of the multiple images and the K1 images adjacent to the any one of the multiple images (operation S223) may include operations S2231 to S2232.

In operation S2231, a first set of images whose first degrees of similarity with the quantized feature of the any one of the multiple images is greater than a first threshold are selected from among the K1 images adjacent to any one of the multiple images;

In operation S2232, all images in the first set of images and the any one of the multiple images are labeled as being in a first state and a cluster is formed based on each of images that are labeled as being in the first state. The first state is a state in which the images include a same object.

In some possible implementations, after the K1 images (the K1 images whose quantized features have the greatest first degrees of similarity) adjacent to each image, the images whose first degrees of similarity are greater than the first threshold are directly selected from among the K1 images adjacent to the image. The selected images whose first degrees of similarity are greater than the first threshold constitute the first set of images. The first threshold may be a value that can be set such as 90%. But the first threshold does not serve as a specific limitation on the embodiment of the disclosure. Images nearest any image may be selected by setting the first threshold.

After the first set of images whose first degrees of similarity are greater than the first threshold are selected from among the K1 images adjacent to the any one of the multiple images, the any one of the multiple images and all the images in the selected first set of images may be labeled as being in the first state and a cluster is formed according to the images in the first state. For example, if images that have the first degrees of similarity greater than the first threshold are selected from among K1 images adjacent to an image A as a first set of images including an image A1 and an image A2, A may be respectively labeled as being in the first state together with A1 and A2; if images that have the first degrees of similarity greater than the first threshold are selected from among K1 images adjacent to the image A1 as a first set of images including an image B1, A1 and B1 may be labeled as being in the first state; if none of K1 images adjacent to A2 have first degrees of similarity greater than the first threshold, A2 is no longer labeled as being in the first state. In the above example, A, A1, A2 and B1 may be placed in a cluster, which means that A, A1, A2 and B1 include a same object.

The above manner makes it convenient to obtain the clustering result. Since the number of image features is reduced by means of the quantized features, the clustering may become faster. An accuracy of the clustering may be increased by setting the first threshold.

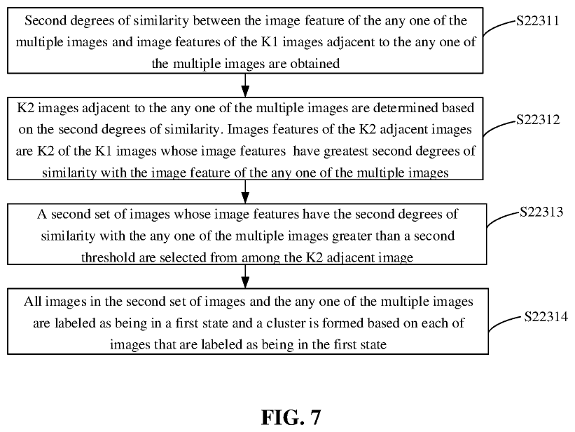

In some other possible embodiments, the accuracy of the clustering may be increased in combination with the degrees of similarity between the image features. FIG. 7 is another flowchart of operation S223 in an image processing method according to an embodiment of the disclosure. The operation that the clustering result of the clustering processing is determined using the any one of the multiple images and the K1 images adjacent to the any one of the multiple images (operation S223) may include operations S22311 to S22314.

In operation S22311, second degrees of similarity between the image feature of the any one of the multiple images and image features of the K1 images adjacent to the any one of the multiple images are obtained.

In some possible implementations, after the K1 images adjacent to the any one of the multiple images (the K1 images whose quantized features have greatest first degrees of similarity) are obtained, the second degrees of similarity between the image feature of the any one of the multiple images and the image features of the corresponding K1 adjacent images may be further calculated. In other words, after the K1 images adjacent to the any one of the multiple images are obtained, the second degrees of similarity between the image feature of the any one of the multiple images and the image features of the K1 adjacent images may be further calculated. The second degree of similarity may be a cosine degree of similarity or the degrees of similarity may be determined in other manners in other embodiments. The disclosure is not limited specifically thereto.

In operation S22312, K2 images adjacent to the any one of the multiple images are determined based on the second degrees of similarity. Images features of the K2 adjacent images are K2 of the K1 images whose image features have greatest second degrees of similarity with the image feature of the any one of the multiple images, where K2 is an integer greater than or equal to 1 and less than or equal to K1

In some possible implementations, the second degrees of similarity between the image feature of the any one of the multiple images and the image features of the corresponding K1 adjacent images may be obtained; and K2 image features whose second degrees of similarity with the image feature of the any one of the multiple images are greatest are further selected; and finally the images corresponding to the K2 image features are determined as the K2 images adjacent to the any one of the multiple images. K2 may be set on demand.

In operation S22313, a second set of images whose image features have the second degrees of similarity with the any one of the multiple images greater than a second threshold are selected from among the K2 adjacent image.

In some possible implementations, after the K2 images adjacent to each of the multiple images (the K2 images whose image features have the greatest second degrees of similarity) are obtained, the images whose second degrees of similarity are greater than the second threshold may be selected directly from among the K2 images adjacent to the any one of the multiple images; the selected images may constitute the second set of images. The second threshold may be a value that can be set such as 90% but does not act as a specific limitation on the embodiment of the disclosure. The images nearest to any image may be selected by setting the second threshold.

In operation S22314, all images in the second set of images and the any one of the multiple images are labeled as being in a first state and a cluster is formed based on each of images that are labeled as being in the first state. The first state is a state in which the images include a same object.

In some possible implementations, after the second set of images whose image features have the second degrees of similarity with the image feature of any one of the multiple images greater than the second threshold are selected from among the K2 images adjacent to the any one of the multiple images, the any one of the multiple images and all the images in the selected second set of images may be labeled as being in the first state and a cluster is formed according to the images in the first state. For example, if an image A3 and an image A4 whose second degrees of similarity are greater than the second threshold are selected from among K2 images adjacent to an image A, A, A3 and A4 may be labeled as being in the first state; if an image B2 whose second degree of similarity is greater than the second threshold is selected from K2 images adjacent to A3, A3 and B2 may be labeled as being in the first state; if none of the K2 images adjacent to A4 have second degrees of similarity greater than the second threshold, A4 is no longer labeled as being in the first state. In the above example, A, A3, A4 and B2 may be placed in a cluster, which means that the images A, A3, A4 and B2 include a same object.

The above manner makes it convenient to obtain a clustering result. Since the number of image features is reduced by means of the quantized features and the K2 adjacent images having the most similar image features are further determined from among the K1 adjacent images obtained based on the quantized features, the clustering is sped up and an accuracy of the clustering is further increased. In addition, a distributed and parallel manner may be adopted in calculating the degrees of similarity between the quantized features and the degrees of similarity between the image features so that the clustering is sped up.

At least one cluster may be obtained after clustering processing is performed. Each cluster may include at least one image. Images in a same cluster may be considered to include a same object. The method may also include a following operation: after the clustering processing is performed, a cluster center of each of the obtained clusters is determined. In some possible implementations, the operation that the cluster center of each of the obtained clusters is determined includes a following operation: the cluster center of each cluster is determined based on an average value of image features of all images in the cluster. After the cluster centers are obtained, fourth indexes may also be allocated to the cluster centers to make the clusters corresponding to all the cluster centers distinguished from each other, and the fourth indexes are stored in association with the cluster centers corresponding to respective fourth indexes. In other words, each image in the embodiment of the disclosure includes a third index serving as an image identifier, a first indexes serving as an identifier of the first group of the image feature, a second index serving as an identifier of a second group where the quantized feature is, the fourth index serving as an identifier of the clusters The above indexes may be stored in association with data such as the corresponding features and images. There may be indexes of other feature data in other embodiments. The embodiment of the disclosure is not specifically limited thereto. In addition, the third indexes of the images, the first indexes of the first groups of the image features, the second indexes of the second groups of the quantized features and the fourth indexes of the clusters are all different from each other and may be represented by different symbols or identifiers.

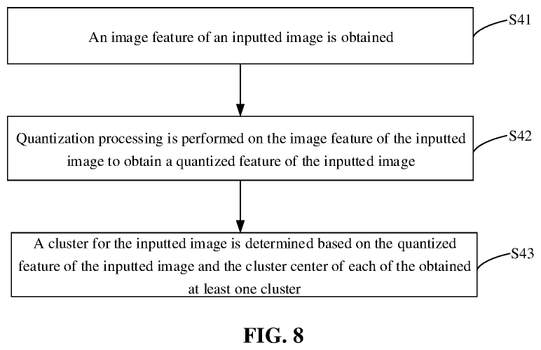

In addition, in the embodiment of the disclosure, after multiple clusters are obtained, the clustering processing may be performed on the received images to determine the clusters that the received images belong to, that is to say, incremental processing of the clusters is performed. After the clusters that the received images match are determined, the received images may be allocated to corresponding clusters. If a current cluster matches none of the received images, the received images may be put in a separate cluster or the received images may fuse with the image data set to make the clustering processing performed again. FIG. 8 is a flowchart of performing clustering incremental processing in an image processing method according to an embodiment of the disclosure. The clustering incremental processing may include operations S41 to S43.

In operation S41, an image feature of an inputted image is obtained.

In some possible implementations, the inputted image may be an image acquired by an image-acquiring device in real time, an image transmitted through other devices, or an image stored locally. The embodiment of the disclosure is not limited thereto. After the inputted image is obtained, the image feature of the inputted image may be obtained. The image feature may be obtained through a feature-acquiring algorithm or through at least one layer of convolutional processing performed by a convolutional neural network, which is identical to the acquisition of the image features in the above embodiments. The image may be a human face image and its corresponding image feature is a human face feature.

In operation S42, the quantization processing is performed on the image feature of the inputted image to obtain a quantized feature of the inputted image.

After the image feature is obtained, the quantization processing may be further performed on the image feature to obtain the corresponding quantized feature. The inputted image obtained in the embodiment of the disclosure may include one or more images. A distributed and parallel manner may be adopted to obtain the image feature and perform the quantization processing on the image feature. The detailed parallel process is identical to the process described in the above embodiments and will not be repeated herein.

In operation S43, a cluster for the inputted image is determined based on the quantized feature of the inputted image and the cluster center of each of the obtained at least one cluster.

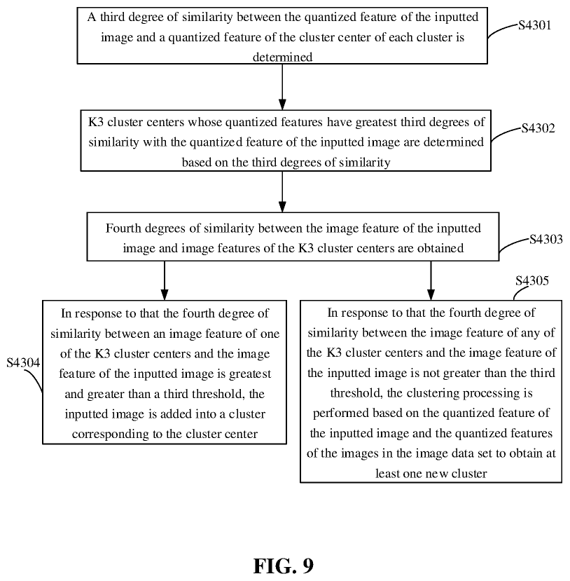

After the quantized feature of the image is obtained, the cluster for the inputted image may be determined based on the quantized feature and the cluster center of each cluster. FIG. 9 is a flowchart of operation S43 in an image processing method according to an embodiment of the disclosure. The operation that the cluster for the inputted image is determined based on the quantized feature of the inputted image and the cluster center of each of the obtained at least one cluster (operation S43) may include operations S4301 to S4305.

In operation S4301, a third degree of similarity between the quantized feature of the inputted image and a quantized feature of the cluster center of each cluster is determined.

As mentioned above, the cluster center of each cluster (or an image feature of the cluster center) may be determined according to an average of the image features of all images in the cluster, which accordingly also enables the quantized feature of the cluster center to be obtained. For example, quantization processing may be performed on the image feature of the cluster center to obtain the quantized feature of the cluster center or average-value processing may also be performed on the quantized feature of each image in the cluster to obtain the quantized feature of the cluster center.

Furthermore, the third degree of similarity between the quantized feature of the inputted image and the quantized feature of the cluster center of each cluster may be obtained. Likewise, the third degree of similarity may be a cosine degree of similarity but does not serve as a specific limitation on the embodiment of the disclosure.

In some possible implementations, multiple cluster centers may be grouped to obtain multiple cluster center groups; the multiple cluster center groups are respectively allocated to multiple arithmetic units; and the cluster center allocated to one arithmetic unit is different from the cluster center allocated to another arithmetic unit. The parallel, respective determination of the third degrees of similarity between the quantized features of the cluster centers in each cluster center group and the quantized feature of the inputted image performed by the multiple arithmetic units can make the processing faster.

In operation S4302, K3 cluster centers whose quantized features have greatest third degrees of similarity with the quantized feature of the inputted image are determined based on the third degrees of similarity. K3 is an integer greater than or equal to 1.

After the third degrees of similarity between the quantized feature of the inputted image and the quantized features of the cluster centers of the clusters are obtained, the K3 cluster centers having greatest degrees of similarity may be obtained. K3 is less than the number of the clusters. The obtained K3 cluster centers may represent K3 clusters that match the inputted object most.

In some possible implementations, the third degree of similarity between the quantized feature of the inputted image and the quantized feature of the cluster center of each cluster may be obtained in a distributed and parallel manner. The cluster centers may be grouped and different arithmetic units calculate the degrees of similarity between the quantized features of the cluster centers in the corresponding groups. By doing so, the calculation becomes faster.

In operation S4303, fourth degrees of similarity between the image feature of the inputted image and image features of the K3 cluster centers are obtained.

In some possible implementations, after the first K3 of the cluster centers sequenced according to a descending order of third degrees of similarity with the quantized feature of the inputted image are obtained, the fourth degrees of similarity between the image feature of the inputted image and the image features of the corresponding K3 cluster centers may be further obtained. Likewise, the fourth degree of similarity may be a cosine degree of similarity but does not serve as a specific limitation on the embodiment of the disclosure.

Likewise, the fourth degrees of similarity between the image feature of the inputted image and the image features of the corresponding K3 cluster centers may also be calculated in the distributed and parallel manner. For example, the K3 cluster centers may be grouped into multiple groups and be respectively allocated to multiple arithmetic units that may determine the fourth degrees of similarity between the image features of the cluster centers allocated to the arithmetic units and the image feature of the inputted image, which may make the calculation faster.

In operation S4304, in response to that the fourth degree of similarity between an image feature of a one of the K3 cluster centers and the image feature of the inputted image is greatest and greater than a third threshold, the inputted image is added into a cluster corresponding to the cluster center.

In operation S4305, in response to that no cluster centers have fourth degrees of similarity with the image feature of the inputted image greater than the third threshold, the clustering processing is performed based on the quantized feature of the inputted image and the quantized features of the images in the image data set to obtain at least one new cluster.

In some possible implementations, if the fourth degrees of similarity between the inputted image and image features of some of the K3 cluster centers are greater than the third threshold, it may be determined that the inputted image matches a cluster corresponding to the cluster center whose image feature has the greatest fourth degree of similarity with the image feature of the inputted image, that is to say, an object included by the inputted image is same as an object corresponding to the cluster with the greatest fourth degree of similarity; then the inputted image may be added into the cluster. For example, an identifier of the cluster may be allocated to the inputted image so that the identifier is stored in association with the inputted image, thus it may be possible to determine the cluster to which the inputted image belongs.

In some possible implementations, if the fourth degrees of similarity between the image feature of the inputted image and the image features of the K3 cluster centers are all less than the third threshold, it can be determined that the inputted image does not match any of all the clusters. In this case, the inputted image may be placed in a separate cluster or the inputted image may fuse with an existing image data set to obtain a new image data set. Operation S20 is performed again on the new image data set, which means that all images cluster again to obtain at least one new cluster. By doing so, the image data may be clustered accurately.

In some possible implementations, if a change is made to images in a same cluster (for example, a new image is inputted and added into the cluster or clustering processing is performed again), the cluster center of the cluster may be determined again so that the determination of the cluster center becomes more accurate and it becomes convenient to perform the clustering processing in the subsequent process.

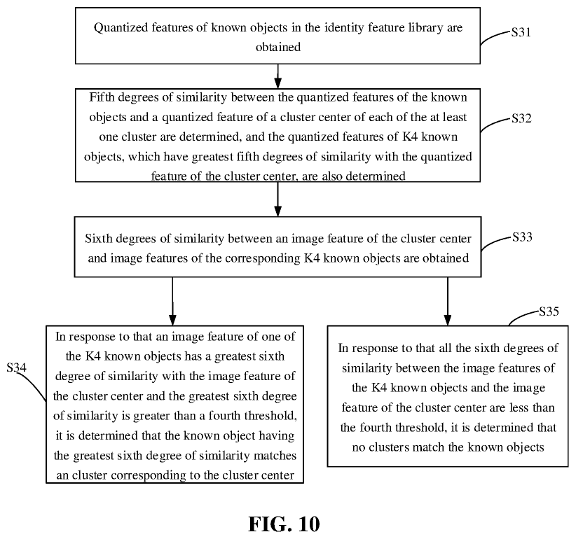

After the images are made to cluster, an object identity matching the images in each cluster may also be determined, which means that the object identity corresponding to each cluster may be determined based on an identity feature of at least one object in an identity feature library. FIG. 10 is a flowchart of determination of an object identity matching a cluster in an image processing method according to an embodiment of the disclosure. The operation that the object identity corresponding to each of the obtained at least one cluster is determined based on the identity features of the at least one object in the identity feature library includes operations S31 to S35.

In operation S31, quantized features of known objects in the identity feature library are obtained.

In some possible implementations, the identity feature library includes object information of multiple known identities that may, for example, include human face images of objects of the known identities and identity information of the objects. The identity information may include basic information such as names, ages and jobs.

Accordingly, the identity feature library may include an image feature and the quantized feature of each known object. The corresponding image feature may be obtained through the human face image of each known object. The quantized feature may be obtained by performing quantization processing on the image feature.

In some possible implementations, the image features and the quantized features of the known objects may be obtained in a distributed and parallel manner. The detailed manner is same as that of the process described in the above embodiment and will not be repeated herein.

In operation S32, fifth degrees of similarity between the quantized features of the known objects and a quantized feature of a cluster center of each of the at least one cluster are determined, and the quantized features of K4 known objects, which have greatest fifth degrees of similarity with the quantized features of the cluster centers, are also determined. K4 is an integer greater than or equal to 1.

In some possible implementations, after the quantized feature of each known object is obtained, the fifth degrees of similarity between the quantized features of the known objects and the quantized feature of the cluster center of each of the obtained at least one cluster are further obtained. The fifth degree of similarity may be a cosine degree of similarity but does not serve as a specific limitation on the disclosure. The quantized features of K4 known objects that have greatest fifth degrees of similarity with the quantized feature of each cluster center are further determined, that is to say, the K4 known objects that have the greatest fifth degrees of similarity with the quantized features of the cluster centers may be found from among the identity feature library. The K4 known objects may be K4 identities that most match the cluster centers.

In some other possible implementations, K4 cluster centers that have the greatest fifth degrees of similarity with the quantized feature of each known object may be obtained. The K4 cluster centers are the ones that most match the identities of the known objects.

Likewise, the quantized features of the known objects may be grouped. Determination of the fifth degrees of similarity between the quantized features of the known objects and the quantized feature of the cluster center of each of the obtained at least one cluster is performed by at least one quantizer, thus may speed up the processing.

In operation S33, sixth degrees of similarity between an image feature of the cluster center and image features of the corresponding K4 known objects are obtained.

In some possible implementations, after the K4 known objects corresponding to each cluster are obtained, the six degrees of similarity between each cluster center and the image features of the corresponding K4 known objects may be further determined. The six degree of similarity may be a cosine degree of similarity but does not serve as a specific limitation on the disclosure.

In some possible implementations, after K4 cluster centers corresponding to a known object are determined and obtained, the six degrees of similarity between the image feature of the known object and the image features of the K4 cluster centers may be further determined. The six degree of similarity may be a cosine degree of similarity but does not serve as a specific limitation on the disclosure.

In operation S34, in response to that an image feature of one of the K4 known objects has a greatest sixth degree of similarity with the image feature of the cluster center and the greatest sixth degree of similarity is greater than a fourth threshold, it is determined that the known object having the greatest sixth degree of similarity matches a cluster corresponding to the cluster center.

In operation S35, in response to that all the sixth degrees of similarity between the image features of the K4 known objects and the image feature of the cluster center are less than the fourth threshold, it is determined that no clusters match the known objects.

In some possible implementations, if the K4 known objects matching the cluster centers are determined and the sixth degrees of similarity between the image features of at least one of the K4 known objects and the image features of the corresponding cluster centers are greater than the fourth threshold, the image features of the known objects with the greatest sixth degrees of similarity may be determined as the image features most matching the cluster centers and the identities of the known objects with the greatest sixth degrees of similarity may be determined as the identities matching the cluster centers. In other words, the identity of each image in the clusters corresponding to the cluster centers is the identity of a known object with the greatest sixth degree of similarity. Alternatively, if it is determined that a known object corresponds to K4 cluster centers and the six degrees of similarity between the image features of some of the K4 cluster centers and the image feature of the known object are greater than the fourth threshold, the cluster centers with the greatest sixth degrees of similarity may be made to match the known object. In this case, the clusters corresponding to the cluster centers with the greatest sixth degrees of similarity match the identity of the known object so that the identities of the objects of the corresponding clusters are determined.

In some possible implementations, in a situation that K4 known objects matching the cluster centers are determined, if the sixth degrees of similarity between the image features of the K4 known objects and the image features of the corresponding cluster centers are all less than the fourth threshold, it is shown that there exists no identity objects that match the cluster centers. Alternatively, in a situation that K4 cluster centers match a known object, if the sixth degrees of similarity between the image features of the K4 cluster centers and the image feature of the known object are all less than the fourth threshold, it is shown that no identities in the obtained clusters match the known object.

In conclusion, the clustering processing may be performed based on the quantized features of the images, thus the clustering processing may be sped up. Furthermore, identity-recognizing processing may also be performed based on the quantized features so that the identity recognition may be sped up on the premise that an accuracy of the identity recognition is ensured.

It can be understood that all above the method embodiments of the disclosure may combine with each other to form a combined embodiment without departing from the principles and the logics. Due to a limited space, the details will not be given in the disclosure.

In addition, an image processing device, an electronic device, a computer-readable storage medium and a program, which all may be used to implement any of the image processing methods provided in the disclosure, are also provided in the embodiments of the disclosure. The descriptions of their corresponding methods should be referred to for their corresponding technical solutions, descriptions. Details will not be repeated.

Those skilled in the art may understand that in the above methods in the detailed descriptions, an order in which all operations are written does not mean a strict order in which they are performed and do not bring any limitation on their implementation processes. The order in which the operations are performed should be determined by their functions and possible internal logics.

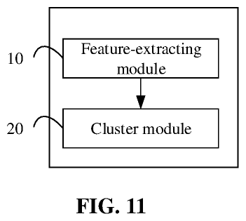

FIG. 11 is a block diagram of an image processing device according to an embodiment of the disclosure. As illustrated in FIG. 11, the image processing device includes a feature-extracting module 10 and a cluster module 20.

The feature-extracting module 10 is configured to perform feature-extracting processing on multiple images in an image data set to obtain image features respectively corresponding to the multiple images.

The cluster module 20 is configured to perform clustering processing on the multiple images based on the obtained image features to obtain at least one cluster. Images in a same cluster include a same object. A distributed and parallel manner is adopted to perform the feature-extracting processing and at least one processing procedure of the clustering processing.

In some possible implementations, the feature-extracting module 10 is configured to group the multiple images in the image data set to obtain multiple image groups; and input the multiple image groups respectively into multiple feature-extracting models and perform the feature-extracting processing on the images in the image groups corresponding to respective feature-extracting models in a parallel manner using the multiple feature-extracting models to obtain the image features of the multiple images. The image groups inputted into respective feature-extracting models are different from each other.

In some possible implementations, the cluster module 20 includes a quantizing unit and a cluster unit. The quantizing unit is configured to perform quantization processing on the image features to obtain quantized features corresponding to the respective image features. The cluster unit is configured to perform the clustering processing on the multiple images based on the obtained quantized features to obtain the at least one cluster.

In some possible implementations, the quantizing unit is further configured to perform grouping processing on the image features of the multiple images to obtain multiple first groups, the first group including the image features of at least one image; and perform the quantization processing on the image features of the multiple first groups in the distributed and parallel manner to obtain the quantized features corresponding to the respective image features.

In some possible implementations, the device further includes a first index configuring module configured to configure a first index for each of the multiple first groups to obtain multiple first indexes. The quantizing unit is further configured to allocate each of the multiple first indexes to a respective one of multiple quantizers, herein the first indexes allocated to respective quantizers are different from each other; and perform the quantization processing on the image features in the first groups corresponding to respective allocated first indexes in a parallel manner using the multiple quantizers.

In some possible implementations, the quantization processing includes PQ encoding processing.

In some possible implementations, the cluster unit is further configured to obtain first degrees of similarity between the quantized feature of any one of multiple images and the quantized features of other images of the multiple images; determine K1 images adjacent to the any one of the multiple images based on the first degrees of similarity, the quantized features of the K1 adjacent images being the first K1 of the quantized features sequenced according to a descending order of the first degrees of similarity with the quantized feature of the any one of the multiple images and K1 being an integer greater than or equal to 1; and determine a clustering result of the clustering processing using the any one of the multiple images and the K1 images adjacent to the any one of the multiple images.

In some possible implementations, the cluster unit is further configured to: select, from among the K1 adjacent images, a first set of images whose first degrees of similarity with the quantized feature of the any one of the multiple images are greater than a first threshold; and label all images in the first set of images and the any one of the multiple images as being in a first state, and form a cluster based on each of images that are labeled as being in the first state. The first state is a state in which the images include a same object.

In some possible implementations, the cluster unit is further configured to: obtain second degrees of similarity between the image feature of the any one of the multiple images and image features of the K1 images adjacent to the any one of multiple images; determine K2 images adjacent to the any one of the multiple images based on the second degrees of similarity, herein images features of the K2 adjacent images being first K2 of the image features sequenced according to a descending order of the second degrees of similarity with the image feature of the any one of the multiple images from among the image features of the K1 adjacent images, where K2 is an integer greater than or equal to 1 and less than or equal to K1; select, from among the K2 adjacent images, a second set of images whose image features have the second degrees of similarity with the any one of the multiple images greater than a second threshold; and label all images in the second set of images and the any one of the multiple images as being in a first state, and form a cluster based on each of images that are labeled as being in the first state. The first state is a state in which the images include a same object.

In some possible implementations, the cluster unit is further configured to perform the grouping processing on the quantized features of the multiple images to obtain multiple second groups before obtaining the first degrees of similarity between the quantized feature of any one of the multiple images and the quantized features of the other images of the multiple images, the second group including the quantized feature of at least one image;

the cluster unit is further configured to obtain the first degrees of similarity between the quantized features of the images in the second groups and the quantized features of the other images in the distributed and parallel manner.

In some possible implementations, the device further includes a second index configuring unit configured to configure a second index for each of the multiple second groups to obtain multiple second indexes before the cluster unit obtains the first degrees of similarity between the quantized features of the images in the second groups and the quantized features of the other images in the distributed and parallel manner.

the cluster unit is further configured to establish a similarity degree calculation task corresponding to the second indexes based on the second indexes, the similarity degree calculation task obtaining the first degrees of similarity between a quantized feature of a target image in each of the second groups corresponding to a respective one of the second indexes and the quantized features of all images other than the target image in the second group; and carries out a similarity degree acquisition task corresponding to each of the multiple second indexes in the distributed and parallel manner.

In some possible implementations, the device further includes a storing module configured to obtain third indexes of the image features, and store the third indexes in association with the image features corresponding to respective third indexes.

The third index includes at least one of: a time when or a position where an image corresponding to the third index is acquired by an image capturing device, or an identifier of the image capturing device.

In some possible implementations, the cluster module further includes a cluster center determining unit configured to determine a cluster center of each of obtained at least one cluster, and controlled to configure fourth indexes for the cluster centers, and store the fourth indexes in association with the cluster centers corresponding to respective fourth indexes.

In some possible implementations, the cluster center determining unit is further configured to determine the cluster center of each cluster based on an average of image features of all images in the cluster.

In some possible implementations, the device further includes an obtaining module and a quantizing module. The obtaining module is configured to obtain an image feature of an inputted image.

The quantizing module is configured to perform the quantization processing on the image feature of the inputted image to obtain a quantized feature of the inputted image.

The cluster module is further configured to determine a cluster for the inputted image based on the quantized feature of the inputted image and a cluster center of each of obtained at least one cluster.

In some possible implementations, the cluster module is further configured to obtain a third degree of similarity between the quantized feature of the inputted image and a quantized feature of the cluster center of each cluster; determine first K3 of the cluster centers sequenced according to a descending order of third degrees of similarity with the quantized feature of the inputted image, K3 being an integer greater than or equal to 1; obtain fourth degrees of similarity between the image feature of the inputted image and image features of the K3 cluster centers; and, in response to that the fourth degree of similarity between an image feature of one of the K3 cluster centers and the image feature of the inputted image is greatest and greater than a third threshold, add the inputted image into a cluster corresponding to the first cluster center.

In some possible implementations, the cluster module is further configured to, in response to that no cluster centers have fourth degrees of similarity with the image feature of the inputted image greater than the third threshold, perform the clustering processing based on the quantized feature of the inputted image and the quantized features of the images in the image data set to obtain at least one new cluster.

In some possible implementations, the device further includes an identity recognizing module, configured to determine an object identity corresponding to each of obtained at least one cluster based on an identity feature of at least one object in an identity feature library.

In some possible implementations, the identity recognizing module is further configured to: obtain quantized features of known objects in the identity feature library; determine fifth degrees of similarity between the quantized features of the known objects and a quantized feature of s cluster center of each of the at least one cluster, and determine the quantized features of K4 known objects, which have greatest fifth degrees of similarity with the quantized feature of the cluster center; obtain sixth degrees of similarity between an image feature of the cluster center and image features of the corresponding K4 known objects; and, in response to that an image feature of one of the K4 known objects has a greatest sixth degree of similarity with the image feature of the cluster center and the greatest sixth degree of similarity is greater than a fourth threshold, determine the known object having the greatest sixth degree of similarity matches an cluster corresponding to the cluster center.

In some possible implementations, the identity recognizing module is further configured to, in response to that all the sixth degrees of similarity between the image features of the K4 known objects and the image feature of the cluster center are less than the fourth threshold, determine that no clusters match the known objects.

Functions or modules included in the device provided in some embodiments of the disclosure may be used for performing the method described in the above method embodiments. The descriptions of the above method embodiments may be referred to for the detailed implementation of device, which are not elaborated herein for the sake of brevity.

A computer-readable storage medium is also provided in an embodiment of the disclosure. Computer program instructions that implements the above method when executed by the processor are stored in the computer-readable storage medium. The computer-readable storage medium may be a non-volatile computer-readable storage medium.

An electronic device is also provided in an embodiment of the disclosure. The electronic device includes a processer and a memory used for storing instructions executable by the processor. The processor is configured to perform the above method.

The electronic device may be provided as a terminal, a server or devices in other forms.

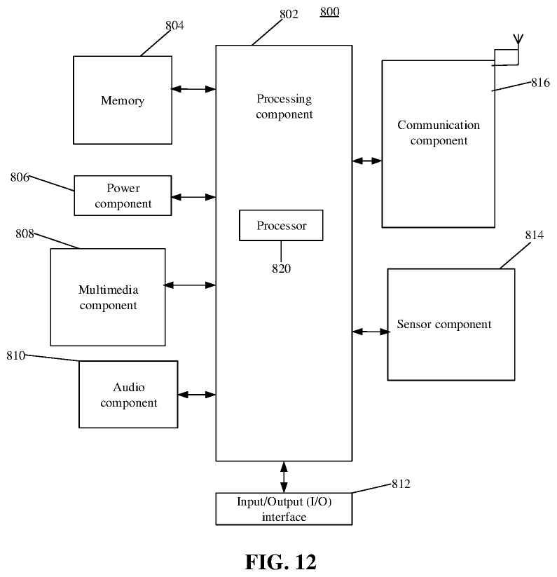

FIG. 12 is a block diagram of an electronic device according to an embodiment of the disclosure. For example, the electronic device 800 may be a terminal such as a mobile phone, a computer, a digital broadcast terminal, a messaging device, a gaming console, a tablet, a medical device, exercise equipment and a personal digital assistant and so on.

As illustrated in FIG. 12, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above-mentioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capability.

The audio component 810 is configured to output and/or input audio signals. For example, the audio component 810 includes a Microphone (MIC), and the MIC is configured to receive an external audio signal when the electronic device 800 is in an operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic elements, and is configured to perform the above described methods.

In an exemplary embodiment, there is also provided a non-transitory computer-readable storage medium such as the memory 804 including computer program instructions, and the computer program instructions may be executed by the processor 820 of the electronic device 800 to implement the above methods.

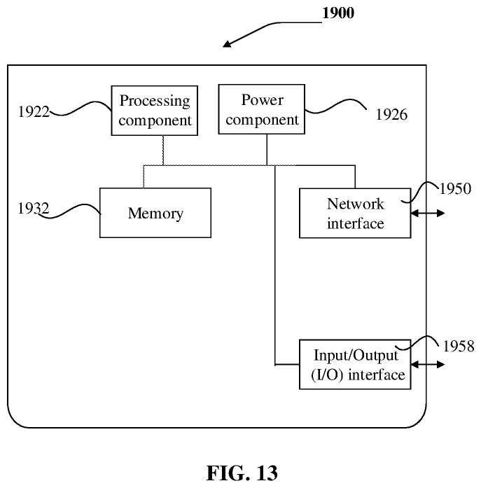

FIG. 13 is another block diagram of an electronic device according to an embodiment of the disclosure. For example, the electronic device 1900 may be provided as a server. As illustrated in FIG. 13, the electronic device 1900 includes a processing component 1922, which further includes one or more processors, and a memory resource which is represented by a memory 1932 and used for storing instructions (such as application programs) executable by the processing component 1922. The application programs stored in the memory 1932 may include one or more modules, each of which corresponds to a group of instructions. Moreover, the processing component 1922 is configured to execute the instructions to perform the above methods.

The electronic device 1900 may further include a power component 1926 configured to conduct power management of the electronic device 1900, a wired or wireless network interface 1950 configured to connect the electronic device 1900 to a network, and an I/O interface 1958. The device 1900 may operate based on an operation system stored in the memory 1932, such as Windows Server™, Mac OS X™, Unix™, Linux™, FreeBSD™ and the like.

In an exemplary embodiment, there is also provided a non-transitory computer-readable storage medium such as the memory 1932 including computer program instructions, and the computer program instructions may be executed by the processing component 1922 of the electronic device 1900 to implement the above methods.

The embodiment of the disclosure may be a system, a method and/or a computer program product. The computer program product may include the computer-readable storage medium which is loaded with the computer-readable program instructions used for enabling a processor to implement each aspect of the disclosure.

The computer-readable storage medium may be a tangible device that can keep and store instructions used by an instruction-executing device. The computer-readable storage medium may be but is not limited to, for example, an electric storage device, a magnetic storage device, an optical storage device, an electromagnetic storage device, a semiconductor storage device or any suitable combination of the aforementioned devices. More specific examples (an non-exhaustive list) of the computer-readable storage medium include: a portable computer disk, a hard disk, a Random Access Memory (RAM), a Read-Only Memory (ROM), an EPROM (or a flash memory), an SRAM, a Compact Disc Read-Only Memory (CD-ROM), a Digital Video Disk (DVD), a memory stick, a floppy disk, a mechanical encoding device, a punched card where instructions are stored or a protruding structure in a groove or any suitable combination thereof. The computer-readable storage medium used herein is not described as an instant signal such as a radio wave, other electromagnetic waves propagating freely, an electromagnetic wave propagating through a wave guide or other transmission media such as an optical pulse passing through a fiber-optic cable or an electric signal transmitting through electric wires.

The computer-readable program instructions described herein may be downloaded onto each computing or processing device from the computer-readable storage medium or onto an external computer or an external storage device through a network such as the Internet, a Local Area Network (LAN), a Wide Area Network (WAN) and/or a wireless network. The network may include a copper-transmitted cable, fiber-optic transmission, wireless transmission, a router, a firewall, a switch, a gateway computer and/or an edge server. A network adapter card or a network interface in each computing/processing device receives the computer-readable program instructions from the network and relays the computer-readable program instructions so that the computer-readable program instructions are stored in the computer-readable storage medium in each computing/processing device.

The computer program instructions used for performing the operations of the disclosure may be assembly instructions, Instruction Set Architecture (ISA) instructions, machine instructions, machine-related instructions, micro-codes, firmware instructions, state-setting data, source codes or target codes that are written in one programming language or any combination of several programming languages. The programming languages include object-oriented languages such as Smalltalk, C++, conventional procedure-oriented languages such as a “C” language or similar programming languages. The computer-readable program instructions can be completely or partially executed on a user computer, or executed as a separate software package. The computer-readable program instructions may also be partially executed on the user computer with the remaining executed on the remote computer, or completely executed on the remote computer or a server. In the case of the remote computer, the remote computer may connect to the user computer through any kind of network that includes the LAN and the WAN, or may connect to the external computer (for example, the remote computer may make the connection through the Internet with the help of an Internet service provider). In some embodiments, state information of the computer-readable program instructions is adopted to personalize an electric circuit such as a programmable logic circuit, a Field Programmable Gate Array (FPGA) and a Programmable Logic Array (PLA). The electric circuit may execute the computer-readable program instructions to implement each aspect of the disclosure.

Each aspect of the disclosure is described herein with reference to the flowcharts and block diagrams of the method, the device (the system) and the computer program product according to the embodiments of the disclosure. It should be understood that each block in the flowcharts and/or the block diagrams and combinations of each block in the flowcharts and/or the block diagrams may be implemented by the computer-readable program instructions.

The computer-readable program instructions may be provided to the processor of a general-purpose computer, a specific-purpose computer or another programmable data-processing device to produce a machine so that these instructions produce a device that implements functions/actions specified in one or more blocks in the flowcharts and/or the block diagrams, when executed through the processor of the computer or another programmable data-processing device. The computer-readable program instructions may also be stored in the computer-readable storage medium to make the computer, the programmable data-processing device and/or other devices to work in a specific manner. In this case, the computer-readable medium where the instructions are stored include a manufactured product that includes the instructions for implementing each aspect of the functions/the actions specified in one or more blocks in the flowcharts and/or the block diagrams.

The computer-readable program instructions may also be loaded on the computer, other programmable data-processing devices or other devices to make a series of operations performed on the computer, other programmable data-processing devices or other devices and establish procedures implemented by the computer so that the instructions executed in the computer, other programmable data-processing devices, or other devices implement the functions/the actions in one or more blocks of flowcharts and/or the block diagrams.

The flowcharts and the block diagrams in the accompanying drawings illustrate systems, architectures, functions and operations that are possibly implemented by the system, method and the computer program product according to the multiple embodiments of the disclosure. At this point, each block in the flowcharts or the block diagrams may represent a module, a program segment or a part of the instructions. The module, the program segment or the part of the instructions include one or more executable instructions used for implementing specified logical functions. In some implementations that serve as substitutes, the annotated functions in the block may also happen in an order different from the annotated order in the accompanying drawings. For example, depending on the relevant functions, two adjacent blocks actually may be basically executed in parallel or sometimes in opposite orders. It should also be noted that each block or a combination of the blocks in the block diagrams and/or the flowcharts may be implemented by a specific hardware-based system for performing specified functions or actions or be implemented by a combination of specific hardware and computer instructions.

Each embodiment of the disclosure has been described above. The above descriptions are not exhaustive but exemplary and are also not limited to each of the disclosed embodiments. Many changes and modifications are apparent to those of ordinary skills in the art without departing from the scope and the spirit of each of the described embodiments. The terminology used herein is chosen to best explain the principles, the practical applications or the improvement of the technologies in the market mentioned in each embodiment or enable others of ordinary skills in the art to understand each embodiment disclosed herein.

1. An image processing method, comprising:
performing feature-extracting processing on a plurality of images in an image data set to obtain image features respectively corresponding to the plurality of images; and
performing clustering processing on the plurality of images based on obtained image features to obtain at least one cluster, wherein images in a same cluster comprise a same object,
wherein a distributed and parallel manner is adopted to perform the feature-extracting processing and at least one processing procedure of the clustering processing.

2. The method of claim 1, wherein adopting the distributed and parallel manner to perform the feature-extracting processing comprises:
grouping the plurality of images in the image data set to obtain a plurality of image groups; and
inputting each of the plurality of image groups into a respective one of a plurality of feature-extracting models, and performing the feature-extracting processing on the images in the image groups corresponding to respective feature-extracting models in a parallel manner using the plurality of feature-extracting models to obtain the image features of the plurality of images, wherein the image groups inputted into respective feature-extracting models are different from each other.

3. The method of claim 1, wherein performing the clustering processing on the plurality of images based on the obtained image features to obtain the at least one cluster comprises:
performing quantization processing on the image features to obtain quantized features corresponding to respective image features; and
performing the clustering processing on the plurality of images based on obtained quantized features to obtain the at least one cluster.

4. The method of claim 3, wherein performing the quantization processing on the image features of the images to obtain the quantized features corresponding to the respective image features comprises:
performing grouping processing on the image features of the plurality of images to obtain a plurality of first groups, wherein each first group comprises the image feature of at least one image; and
performing the quantization processing on the image features of the plurality of first groups in the distributed and parallel manner to obtain the quantized features corresponding to the respective image features.

5. The method of claim 4, further comprising: before performing the quantization processing on the image features of the plurality of first groups in the distributed and parallel manner to obtain the quantized features corresponding to the respective image features,
configuring a first index for each of the plurality of first groups to obtain a plurality of first indexes,
wherein performing the quantization processing on the image features of the plurality of first groups in the distributed and parallel manner to obtain the quantized features corresponding to the respective image features comprises:
allocating each of the plurality of first indexes to a respective one of a plurality of quantizers, wherein the first indexes allocated to respective quantizers are different from each other; and
perform the quantization processing on the image features in the first groups corresponding to respective allocated first indexes in a parallel manner using the plurality of quantizers.

6. The method of claim 3, wherein the quantization processing comprises Product Quantization (PQ) encoding processing.

7. The method of claim 3, wherein performing the clustering processing on the plurality of images based on the obtained quantized features to obtain the at least one cluster comprises:
obtaining first degrees of similarity between the quantized feature of any one of the plurality of images and the quantized features of other images of the plurality of images;
determining K1 images adjacent to the any one of the plurality of images based on the first degrees of similarity, wherein the quantized features of the K1 adjacent images are first K1 of the quantized features sequenced according to a descending order of the first degrees of similarity with the quantized feature of the any one of the plurality of images, where K1 is an integer greater than or equal to 1; and
determining a clustering result of the clustering processing using the any one of the plurality of images and the K1 images adjacent to the any one of the plurality of images.

8. The method of claim 7, wherein determining the clustering result of the clustering processing using the any one of the plurality of images and the K1 images adjacent to the any one of the plurality of images comprises:
selecting, from among the K1 adjacent images, a first set of images whose first degrees of similarity with the quantized feature of the any one of the plurality of images are greater than a first threshold; and
labeling all images in the first set of images and the any one of the plurality of images as being in a first state, and forming a cluster based on each of images that are labeled as being in the first state, wherein the first state is a state in which the images include a same object; or
determining the clustering result of the clustering processing using the any one of the plurality of images and the K1 images adjacent to the any one of the plurality of images comprises:
obtaining second degrees of similarity between the image feature of the any one of the plurality of images and image features of the K1 images adjacent to the any one of the plurality of images;
determining K2 images adjacent to the any one of the plurality of images based on the second degrees of similarity, wherein images features of the K2 adjacent images are first K2 of the image features sequenced according to a descending order of the second degrees of similarity with the image feature of the any one of the plurality of images from among the image features of the K1 adjacent images, where K2 is an integer greater than or equal to 1 and less than or equal to K1;
selecting, from among the K2 adjacent images, a second set of images whose image features have the second degrees of similarity with the any one of the plurality of images greater than a second threshold; and
labeling all images in the second set of images and the any one of the plurality of images as being in a first state, and forming a cluster based on each of images that are labeled as being in the first state, wherein the first state is a state in which the images include a same object.

9. The method of claim 7, further comprising: before obtaining the first degrees of similarity between the quantized feature of any one of the plurality of images and the quantized features of the other images of the plurality of images,
performing grouping processing on the quantized features of the plurality of images to obtain a plurality of second groups, wherein each second group comprises the quantized feature of at least one image,
wherein obtaining the first degrees of similarity between the quantized feature of any one of the plurality of images and the quantized features of the other images of the plurality of images comprises:
obtaining the first degrees of similarity between the quantized features of the images in the second groups and the quantized features of the other images in the distributed and parallel manner.

10. The method of claim 9, further comprising: before obtaining the first degrees of similarity between the quantized features of the images in the second groups and the quantized features of the other images in the distributed and parallel manner,
configuring a second index for each of the plurality of second groups to obtain a plurality of second indexes,
wherein obtaining the first degrees of similarity between the quantized features of the images in the second groups and the quantized features of the other images in the distributed and parallel manner comprises:
establishing a similarity degree calculation task corresponding to the second indexes based on the second indexes, wherein the similarity degree calculation task obtains the first degrees of similarity between a quantized feature of a target image in each of the second groups corresponding to a respective one of the second indexes and the quantized features of all images other than the target image in the second group; and
performing a similarity degree acquisition task corresponding to each of the plurality of second indexes in the distributed and parallel manner.

11. The method of claim 1, further comprising:
obtaining third indexes of the image features, and storing the third indexes in association with the image features corresponding to respective third indexes,
wherein the third index comprises at least one of: a time when or a position where an image corresponding to the third index is acquired by an image capturing device, or an identifier of the image capturing device.

12. The method of claim 1, further comprising:
determining a cluster center of each of obtained at least one cluster; and
configuring fourth indexes for the cluster centers, and storing the fourth indexes in association with the cluster centers corresponding to respective fourth indexes.

13. The method of claim 12, wherein determining the cluster center of each of the obtained at least one cluster comprises:
determining the cluster center of each cluster based on an average of image features of all images in the cluster.

14. The method of claim 1, further comprising:
obtaining an image feature of an inputted image;
performing a quantization processing on the image feature of the inputted image to obtain a quantized feature of the inputted image; and
determining a cluster for the inputted image based on the quantized feature of the inputted image and a cluster center of each of obtained at least one cluster.

15. The method of claim 14, wherein determining the cluster for the inputted image based on the quantized feature of the inputted image and the cluster center of each of the obtained at least one cluster comprises:
obtaining a third degree of similarity between the quantized feature of the inputted image and a quantized feature of the cluster center of each cluster;
determining first K3 of the cluster centers sequenced according to a descending order of third degrees of similarity with the quantized feature of the inputted image, where K3 is an integer greater than or equal to 1;
obtaining fourth degrees of similarity between the image feature of the inputted image and image features of the K3 cluster centers; and
in response to that the fourth degree of similarity between an image feature of one of the K3 cluster centers and the image feature of the inputted image is greatest and greater than a third threshold, adding the inputted image into a cluster corresponding to the cluster center,
in response to that no cluster centers have fourth degrees of similarity with the image feature of the inputted image greater than the third threshold, performing the clustering processing based on the quantized feature of the inputted image and the quantized features of the images in the image data set to obtain at least one new cluster.

16. The method of claim 1, further comprising:
determining an object identity corresponding to each of obtained at least one cluster based on an identity feature of at least one object in an identity feature library.

17. The method of claim 16, wherein determining the object identity corresponding to each of the obtained at least one cluster based on the identity feature of the at least one object in the identity feature library comprises:
obtaining quantized features of known objects in the identity feature library;
determining fifth degrees of similarity between the quantized features of the known objects and a quantized feature of a cluster center of each the at least one cluster, and determining the quantized features of K4 known objects, which have greatest fifth degrees of similarity with the quantized feature of the cluster center;
obtaining sixth degrees of similarity between an image feature of the cluster center and image features of the corresponding K4 known objects; and
in response to that an image feature of one of the K4 known objects has a greatest sixth degree of similarity with the image feature of the cluster center and the greatest sixth degree of similarity is greater than a fourth threshold, determining that the known object having the greatest sixth degree of similarity matches an cluster corresponding to the cluster center.

18. The method of claim 17, wherein determining the object identity corresponding to each of the obtained at least one cluster based on the identity features of the at least one object in the identity feature library further comprises:
in response to that all the sixth degrees of similarity between the image features of the K4 known objects and the image feature of the cluster center are less than the fourth threshold, determining that no clusters match the known objects.

19. An image processing device, comprising:
a memory storing processor-executable instructions; and
a processor arranged to execute the stored processor-executable instructions to perform operations of:
performing feature-extracting processing on a plurality of images in an image data set to obtain image features respectively corresponding to the plurality of images; and
performing clustering processing on the plurality of images based on the obtained image features to obtain at least one cluster, wherein images in a same cluster comprise a same object,
wherein a distributed and parallel manner is adopted to perform the feature-extracting processing and at least one processing procedure of the clustering processing.

20. A non-transitory computer-readable storage medium having stored thereon computer-readable instructions that, when executed by a processor, cause the processor to perform an image processing method, the method comprising:
performing feature-extracting processing on a plurality of images in an image data set to obtain image features respectively corresponding to the plurality of images; and
performing clustering processing on the plurality of images based on obtained image features to obtain at least one cluster, wherein images in a same cluster comprise a same object,
wherein a distributed and parallel manner is adopted to perform the feature-extracting processing and at least one processing procedure of the clustering processing.
